(19) United States
(12) Patent Application Publication
(10) Pub. No.: US 2006/0046917 A1
(43) Pub. Date: Mar. 2, 2006

(54) Operating station and operating method for a crossed bottom laying device

(76) Inventors: Ruediger Duwendag, Lengerich (DE); Marco Daher, Wallenhorst (DE); Thomas Hawighorst, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/524,265

(22) PCT Filed: Aug. 29, 2003
(86) PCT No.: PCT/EP03/09662

§ 371 Date: Feb. 11, 2005

(30) Foreign Application Priority Data
Sep. 13, 2002 (DE) 102 42 732.1

(51) Int. Cl. B31B 49/04

(52) U.S. Cl. 493/220

(57) ABSTRACT

An operating station (201) for a bottomer for cross bottom sacks (19),
whereby the bottomming device comprises of a gluing station (30), in which the gluing format (4, 4a, 4b), according to which the components of the sack are to be glued (19), is defined by means of glue traces (3), whose structure is determined through the opening and closing of the valves (32) and
whereby the gluing station (30) is connected with a computing unit (202), with which the selective opening and closing of the valves (32) can be done,
in which the digital target images of the glue traces (3), which define the gluing format (4, 4a, 4b) are stored in the memory (207) of the computing unit (202).

Inventive is the display element (203), with which the glue deposition (208) on the sack components (1, 2, 48) can be displayed. An operating method is described, whereby, the invention is that is the digital target images,
which define the structure of the glue traces (3,44-47) and which are stored, modified and supplemented in the memory (207) of the computing unit (202),
whereby data is transmitted to the operating station (201) through keyboard (205) and/or digital interfaces (209) of the operating station (201).

The invention relates to an operating station and an operating process for a cross bottomer.

In other areas of the technology, an operating station for the steering of a gluing station for generating the glue profiles for gluing of sack components is known in the printed literature. The sack components are subsequently used for building the sacks.

In DE 199 35 117 such a device is proposed for generating the glue profiles of the sacks. The displayed bottomer includes following features:
A gluing station, in which the glue format, which is applied on the components of the sack to be glued, is defined through glue traces and its structure is determined through the opening and the closing of valves and
whereby, the gluing station is connected to a computing unit, with which it is possible to carry out the selective opening and closing of the valves,
whereby, the target images of the glue traces, which define the gluing format, are stored in the memory of the computing unit.

In the devices shown in DE 199 35 117, at first, the glue reaches the valves through a glue feed, and is extruded through its glue release orifices onto a roller. After that, the roller transfers the glue on the sack components. However, neither DE 199 35 117 nor any other publication proposes preparation of the of cross bottom valve sacks with the help of such a device. In order to understand the circumstances, knowledge about the process of the fabrication of various types of sacks is important. In this context, the differences between pinch, chunk and cross bottom sacks should be emphasized. The preparation of the cross bottom sacks is described, for example, in DE 090 145 48 U1 and DE 3020043 A1. In the gluing of the bottom labels and the folded bottoms, particularly large quantities of glue that are difficult to transport, must be spread over a large format width.

In addition to that, the profiles of the glue deposits are in general intermittent, that is, specific areas of the sack components transported in isolated manner are glued. As a result, the glue is not spread in the intermediate gaps.

In case of the cross bottom sacks, either the folded bottoms or the bottom labels assigned to them, or both the aforementioned elements to be glued, are provided with a glue layer and are subsequently brought together.

According to the current status of the technology, the gluing of the respective components of the sack to be glued takes place by bringing a format part fixed on a rotating roller—often called a block—in contact with the glue rollers or other glue storing or glue depositing components during the rotation of the roller, and is thereby impinged with the glue. In the subsequent course of the rotation of the roller, the format plate transfers the glue stored in it on the respective component of the sack to be glued.

For that purpose, the format part is provided with characteristic elevations, which are adjusted to match a particular sack format. If the sacks are to be fabricated with other dimensions of the bottoming device, the format parts are exchanged.

The described method of spreading the glue has proved to be successful in case of bottoming devices for paper sacks, since large quantities of starch glue, which is difficult to handle, can be neatly applied in that manner.

However, the necessity of exchanging the format parts with each change of format is one of the disadvantages of these devices. To make the format parts superfluous, glue formats can be extruded from arrays of valves—that is, from arrangements of glue valves—in a gluing station.

Due to large range of the formats and the variety of that glue formats that are manufactured in the traditional method, it is worthwhile to make the operation at the operating station easier.

Even when the patent DE 199 35 117 stems from an another area of the technology, the essential parts of the preamble of the claim 1 are reproduced from it. The aforementioned task is solved through the characteristic features of the claims 1 and 8.

Those devices according to the invention, which simultaneously enable a central editing of the glue deposition—be it through direct modification of the target image of the glue traces, or through a more indirect modification of the same, for instance, through a modification of the glue format and a subsequent calculation by a computer, of the shape of the glue traces to be applied, spare the machine operator the extensive calculations as well as the possible manual inputs about the length of the glue traces and the widths of the glue contours.

Further examples of the design according to the invention follow from the description of the embodiments and the claims.

The individual figures show:

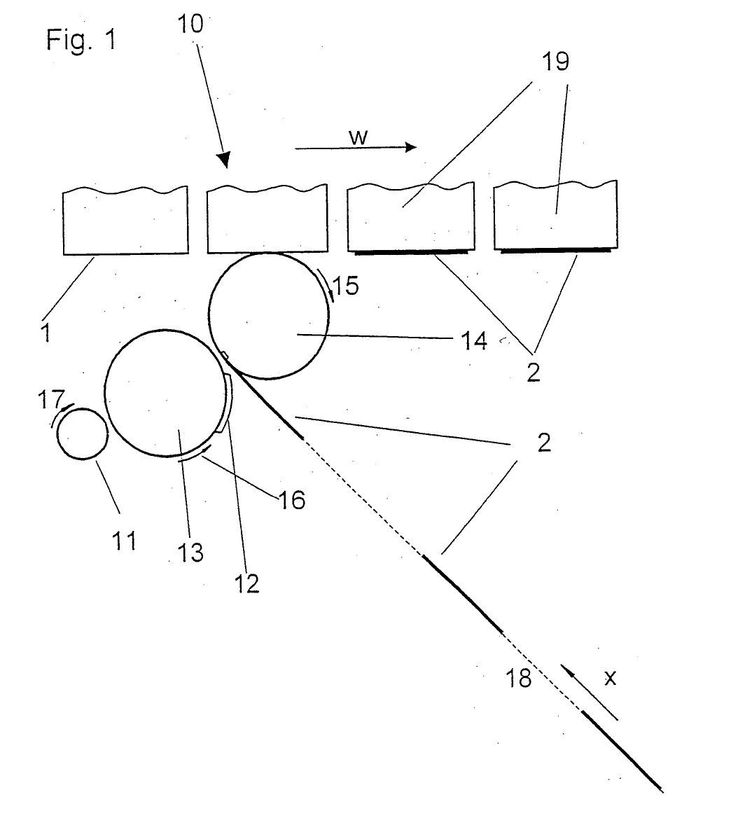

FIG. 1 A glue application device for sack bottom labels according to the present status of the technology

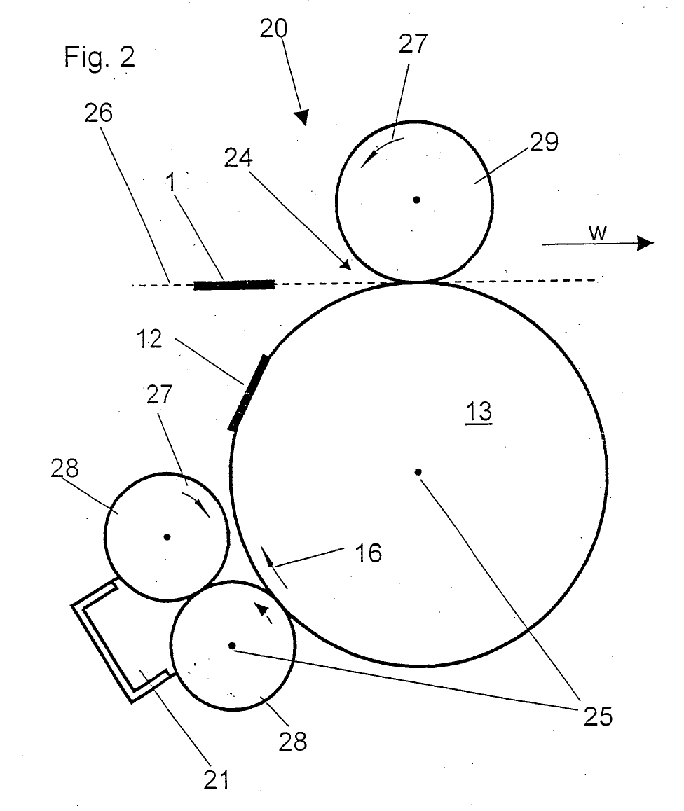

FIG. 2 A glue application device for cross bottoms according to the present status of the technology

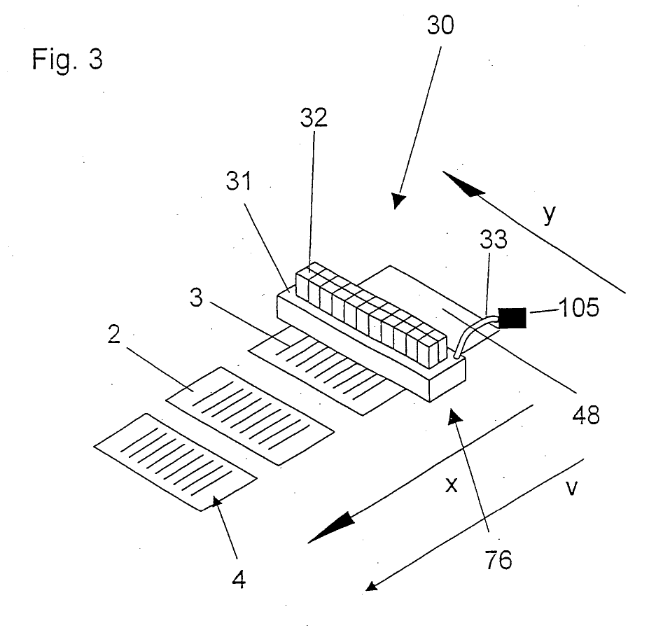

FIG. 3 A view of the new type of the gluing station

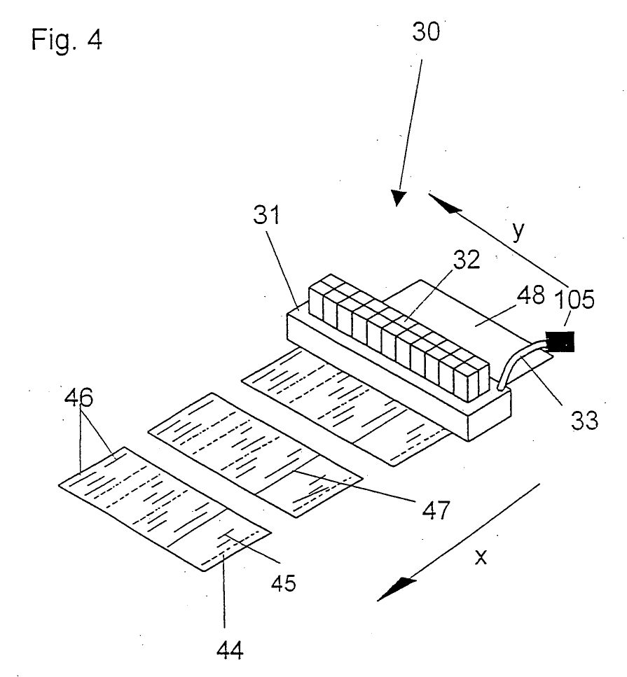

FIG. 4 A view of a new type of gluing station, which generates complicated adhesive formats.

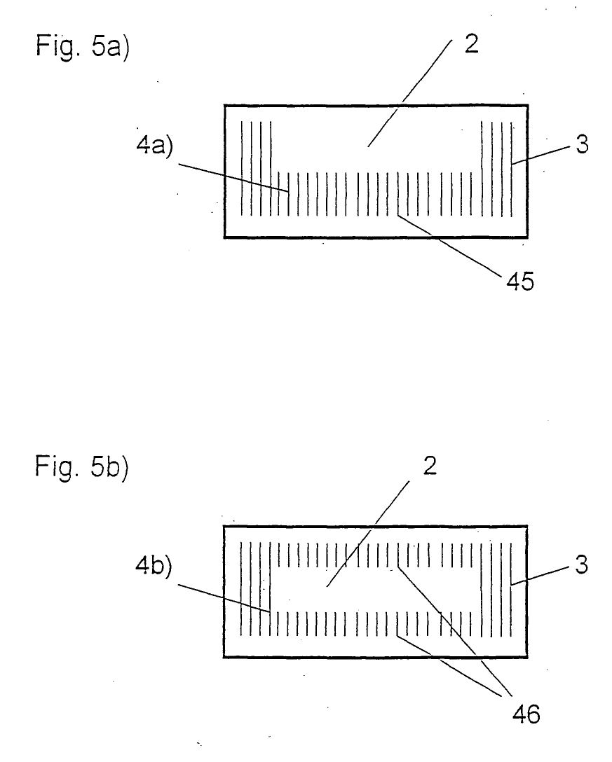

FIG. 5a) A label with a U-shaped gluing format and the corresponding glue traces.

FIG. 5b) A label with a gluing format in the form of a rectangular frame and the corresponding glue traces.

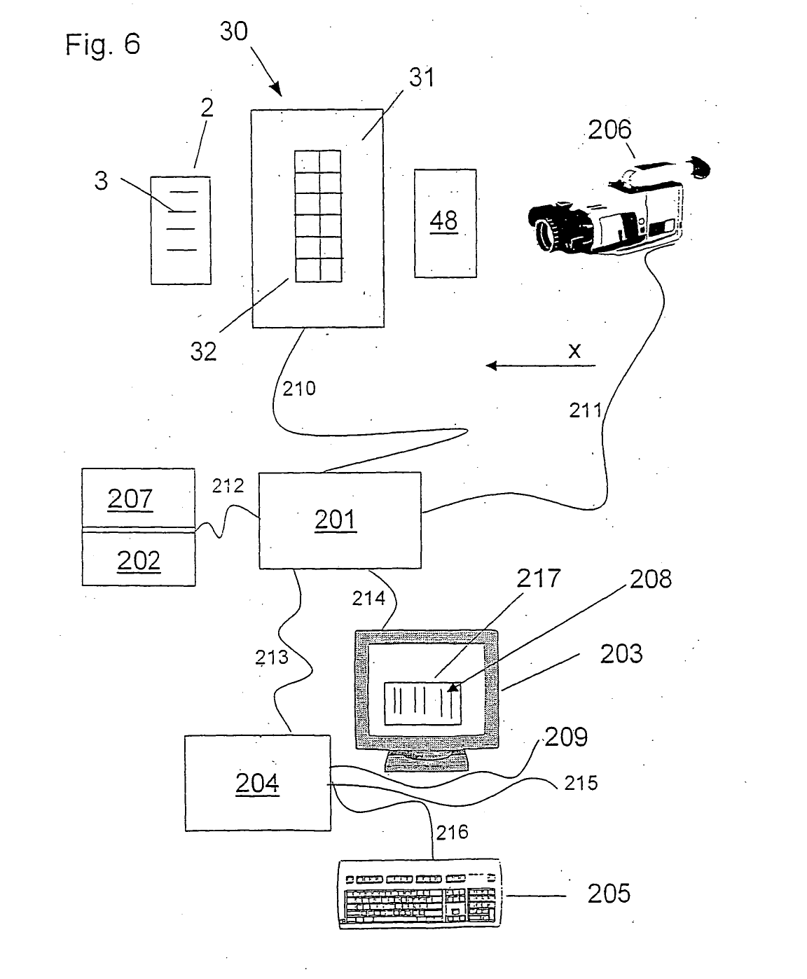

FIG. 6 Schematic structure of the device according to the invention

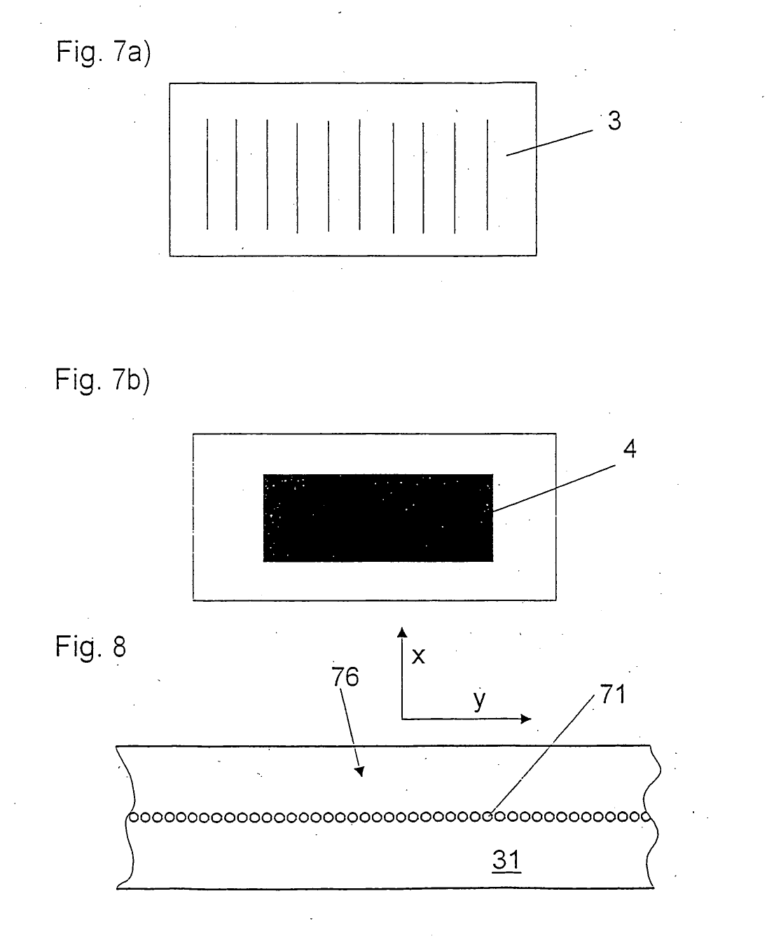

FIG. 7 a) A label 2 with the glue traces

FIG. 7 b) A label 2 with a glue format

FIG. 8 The side of a coating head facing the sack components to be glued

In the following diagrams, the new glue application devices for cross bottom sacks, which can be operated from an operating station according to the invention, as well as the devices according to the present status of the technology are shown. The new type of devices, which are shown, glue only bottom sheets 2. However, they could glue the cross bottoms 1 just as well.

FIG. 1 shows a glue application device, as it is normally used in the gluing of the bottom labels 2 according to the present status of the technology. In this device, the glue from a glue roller 11 is transferred to the format part or block 12, which is conveyed by a block cylinder 13 and moves about the axis of the block cylinder 13 in the direction denoted by the arrow 16. During this rotational movement, the block or the format part 12 transfers the glue to the bottom labels 2, which are conveyed during the glue transfer by the gripper cylinder 14. The bottom labels 2 are previously transported, by a transport device not displayed here, along the broken line 18 in the direction of the arrow x into the slit between the cylinders 13 and 14. The rotation of the gripper cylinder 14 in the direction sketched by the arrow 15 transports the glued labels farther over to the sack bottoms 1, which are transported by a transportation device, also not displayed here, in the direction of the arrow w. The sacks 19 are closed by the sack bottoms 1.

Pressure is built up between the gripper cylinder 14 and the device for the transport of the sacks, the labels 2 and the sack bottoms are pressed together and consequently bond together durably.

FIG. 2 shows another glue deposition device 20 according to the present status of the technology, which is used in general for gluing the sack bottoms 1. To that end, a block or a format part 12, which is attached on the border of the block cylinder 13, is brought in connection with the glue transfer cylinders 28 through the rotation of the block cylinder 13 about its axis 25 in the direction of the arrow 16, and as a result, is impinged with the glue. For that purpose, the format part 12 has indentations, not displayed here, which are filled with glue during the contact with the glue transfer rollers 28.

The glue transfer rollers 28 restrict, on their part, the opening of the glue reservoir 21 and transport, in course of the rotation, glue, along its circumference, from the glue reservoir 21 to the block 12.

The block or the format part 12 reaches the roller slit 24 between the cylinders 29 and 13 in course of the further rotation of the cylinder 13. There, the block 12 transfers glue onto the sack bottom 1. The sack is previously conveyed by a transport device, not displayed here, along the broken line 26 into the roller slit.

In case the sack formats are changed, the format parts 12 of the gluing stations 10 and 20 shown in the FIGS. 1 and 2 are exchanged with format parts that match with the new sack format.

FIG. 3 shows a sketch of a label gluing station 30 of the new type of cross bottomer, which already applies the glue traces 3 on the individual separate labels 2 that are conveyed in the direction of the arrow x. For that purpose, the gluing station 30 is equipped with a coating head 31. Glue is fed to this coating head by means of the hose 33. The glue is distributed in the interior of the coating head 31 by the appropriate glue feeding lines feeding to the valves 32, which are arranged in two rows on the coating head 31, transversally to the direction x of the transport of the labels 2. These valves 32 are at least capable of releasing or stopping the flow of the glue.

They can be steered through external—preferably electrical—signals and they 32 can withstand the pressure of the glue.

On the not displayed lower side of the coating head 31, there are glue release orifices 71, through which glue leaves the coating head 31 and generates the glue traces. Arrow x points in the direction of the transport of the labels 2, while arrow y points in the horizontal direction transversal to it. Arrow v indicates the gluing speed.

FIG. 4 shows a gluing station 30, which is externally built exactly like the gluing station in FIG. 3. The different glue traces 44 to 47 show that the most differing glue formats can be realized with such a device without having to use format parts or blocks. Thereby, a variation in the width of the block, that is, of the expanse of the gluing area in y-direction, is realizable through the switching off or on of the valves 32 during the treatment of the sacks with this gluing format. The valves switched off in this manner are thus not active during the entire duration of the gluing of the labels 2 or of the sack bottoms of a particular format. Preferably, the rectangular glue formats—as shown in FIG. 3—are generated in this manner, in which glue traces 3, 47, of equal lengths in general, are generated.

However, already for that purpose, the valves, which are active during the preparation of the glue format, are closed after the generation of the continuous glue traces 47 and open again with the arrival of the next, yet to be glued, label 48, at the glue release orifices. This processing sequence itself puts, for the gluing speeds common in the industry, considerable demands on the switching time of the valve 32. Should further variations in the form of the gluing format or the quantity of glue be made, then the valves 32 must be opened or closed still faster than that in the case of generating continuous gluing traces 47.

Thus a significant variation in the amount of the deposited glue is possible, especially by depositing glue as traces 44 that are interrupted several times. Further variations in the form of the gluing format—which include significant deviations from the rectangular form—require distribution of shorter 45 and interrupted glue traces 46. For instance, it is often necessary that the gluing formats 4 have the form of a U 4a) or a rectangular frame 4b), as shown in FIGS. 5a) and b). For that purpose, a different steering of the valves during the gluing of the sack constituents 1, 2 is necessary.

It is advantageous, if the valves 32 provided in the bottoming device also have a switching time, or can be switched on or off, for periods shorter than 5 ms. In that case, most of the variations of the gluing formats required in the industry, which can be achieved through variation of individual glue traces in x-direction, can be realized with commonly employed gluing speeds in the manner described above.

One can imagine, from the variety of the glue traces 45 to 47, how flexibly such a device according to this invention can generate formats, if the valves can be switched still faster.

The designs of the new type of the gluing stations shown in FIGS. 3 and 4 are equally suitable for the actual gluing of the already separated labels, as also for the gluing of paper sheets, which can be separated later. In case of sack bottoms also, the gluing can be done in an analogous fashion.

As already mentioned, the FIGS. 5a) and b) show a U-shaped 4a) and a rectangular gluing format 4b) on two labels 2. The U-shaped glue format is composed by making continuous 3 and short 45 glue traces. The glue format in the form of a rectangular frame 4b) is composed by making continuous 3 and interrupted glue traces 46. Different types of runs of the glue traces are realized through selective steering of the glue valves 32 during the gluing of the sack constituents 1, 2 to be glued.

All the described and shown new types of the gluing stations are suitable for direct as well as for indirect gluing of the sack components 1, 2, in which the glue is at first transferred onto a roller or to some other form, before reaching the sack components.

FIG. 6 shows a schematic diagram of a complex device 201 according to the invention.

It 201 is connected with the gluing station 30 and can regulate the valves 32 through the steering cable 210.

In addition to that, the operating station 201 is connected with the digital camera 206 of the computing unit 202, display element 203 and the operating terminal 204 through the connections 211 to 214. The display element 203 shows a label with the glue distribution of just whatsoever type.

The operating terminal 204 establishes connection with the outside world by means of the interfaces 209 and the lines 215 and 216. In general, the concept of the operating terminal in context of this application has to do with a functional concept, which elucidates that the operating station 201 is supplied with the information from the side of the machine operator through the operating terminal. The operating station 201 is also connected with the computing unit 202, which carries out the specific calculations and the steering tasks.

In particular, shortly after taking the bottomer into operation or after retrofitting it with a new type of the gluing station and an operating station, with a design according to the invention, as shown in FIG. 6, there will be few or no digital target images in the memory 207 of the computing element 202. Therefore, the data about the target images of the operating station must be made accessible through the operating terminal 204. This can take place, in the shown device, in that the machine operator undertakes a completely fresh editing of the glue format by means of the keyboard 205. As a rule, however, he will orient to the glue formats 4, which are used in the common gluing stations 10. It is, therefore, advantageous to take these old gluing formats as the basis for the new gluing formats. This can be done by scanning, or photographing with a digital camera, the old gluing formats, or the corresponding format components, or by means of external data carriers (CD, diskette). Important is only that the data is made accessible to the operating terminal 204 through an interface 209. Often, the operator will want to edit the glue formats that are read in, in order to be able to make improvements or adjustments.

Between the processing steps or during the processing, he will let the gluing formats be displayed on the display element.

In order to make this processing step easier, the computing element is in position to calculate the shape of the glue traces 3, 44-47 on the basis of the data for a planar glue format 4, which is necessary for the construction of the glue format 4. After the shape and the positions of the glue traces are determined, the computing element 202 calculates the time points for the opening and the closing of the valves 32, which lead to the generation of the glue traces 3.

At least a part of the data about the sack formats edited and entered through the interface 209 is stored in the memory of the computing unit 207, and is available for later gluing operations. In addition to that, more and more target images of the gluing traces become available in course of time, so that the gluing traces can be edited directly when changes are necessary. As a result, the process of the calculations for the conversion from full area glue formats 4 to glue traces 3 can often become unnecessary.

A further simplification—in this case, for the machine operator—is possible, if the computing element 202 can determine the gluing profile from the geometric data of the sack 19 and its parts to be glued 1,2 and undertake calculations necessary for the definition of the glue tracks. In general, this will happen, by presetting the gluing formats for particular sack formats in the memory. The computing unit can then, for instance, change the dimensions of the stored gluing formats in comparison to the stored and the newly entered sack formats.

A further possibility of making the job easier is realized through the digital camera 206 or by means of some other suitable sensor. With this camera, the dimensions of the sack components 48 are registered and reported to the operating station. The computing unit then selects the matching gluing formats available in its memory 207 or calculates it in the manner described above.

To avoid unclarity on this point, it is explained once again with the help of the FIGS. 7a) and b), that by the glue traces 3 are meant the glue tracks, which are formed during the extrusion of the glue flowing out of the glue release orifices. The new types of gluing station 30 shown in FIGS. 3 and 4 have a large number of such glue release orifices 71 in the lower side of their coating heads 31. In general, this type of glue distribution does not lead immediately to the generation of a glue profile covering the full area, because between the glue traces 3 running along the x-direction, an unglued area of the paper remains. This circumstance can be undesirable, because out of these unglued intermediate areas, after the completion and the filling of the sack 19, substances capable of trickling out can escape.

Therefore, spreading over the whole area can be brought about,
by spraying in the glue on the paper and/or
   by spreading the glue traces thickly, and then smearing up or pressing together the labels 2 and the sack bottom 1 by means of the gluing station, so that the distribution over the whole area takes place.

For the purpose of this application, the gluing format 4 over the full area is identical with the area of the sack components 1, 2, over which the gluing function is also actually realized.

The concept of the glue distribution covers the concepts of glue traces 3 and the glue format 4 as well as all the intermediate stages.

FIG. 8 shows the side 76 of the coating head facing the sack components 1, 2 to be glued, which is not visible in the FIGS. 3 and 4. This figure shows the glue release orifices 71, through which the glue is extruded onto the sack components 1, 2. The glue has previously passed through the valve 32. In general, a single valve 32 supplies several glue release orifices with glue. The glue release orifices lie on one line, which is made possible by means of the conduit of the glue feeding lines in the coating head.

It is particularly advantageous, if the device according to the invention is equipped with a device 205 for adjusting the volume of the glue deposited per unit area. This quantity, or the quantities derivable from that—such as the absolute amount of glue deposition or similar—are important for the quality and the durability of the sack bottoms. The adjustment can follow through the keyboard 205 and the operating terminal 204. The corresponding inputs can then be converted by the computing unit 202 through suitable steering commands for the components of the gluing station 30, which determine the flow of the glue and are transmitted through the connection 210. Among the aforementioned components of the gluing station 30 can belong the pumps, valves or pressure regulators 105.

In a further development of the invention, the operating station is connected with a device for the measurement of the glue deposit and shows the results of the measurements on a display element 203. The devices for the measurement of the glue deposit can consist of flowmeters, which measure the flow of the glue. However, pressure sensors can also be installed at suitable points in the glue feed systems 31, 32, 33. In that case, a computing unit can calculate the quantity flowing through from the pressure values. The pressure values could be displayable in that case.

A further step for making the operability of the new type of the gluing station 30 easier lies in that, both the devices, for the adjustment as well as for the measurement, can consist of the same device. Possibly, the monitoring and the controlling of the glue deposit can be done by means of the interaction of both the mentioned devices with a computing unit 202.

In such a case, the targeted quantity of the glue deposit must be registered by the operating station only once. The adjustment and the monitoring of the quantity of the glue deposit can then follow automatically.

List of Reference Symbols

| v | Gluing speed |
|---|---|
| w | Direction of transport of the sack bottom 1 |
| x | Direction of transport of the label |
| y | Spatial direction transversal to the direction of the |
| | transport of the ticket (horizontal) |
| z | Spatial direction transversal to the direction of the |
| | transport of the ticket (vertical) |
| 1 | Sack bottom |
| 2 | Label |
| 3 | Glue trace |
| 4 | Rectangular gluing format |
| 4a) | U-shaped gluing format |
| 4b) | Gluing format in the form of a rectangular frame |
| 10 | Familiar gluing station, preferably for labels |
| 11 | Glue cylinder |
| 12 | Format block |
| 13 | Format cylinder |
| 14 | Gripper cylinder |
| 15 | Arrow in the direction of rotation of the gripper cylinder 14 |
| 16 | Arrow in the direction of rotation of the block cylinder 17 |
| 17 | Arrow in the direction of rotation of the gluing cylinder 17 |
| 18 | Broken line |
| 19 | Sack |
| 21 | Glue reservoir |
| 24 | Roller slit |
| 25 | Axes of the cylinder |
| 26 | Broken line, sketching the path of the transport of the sacks |
| 27 | Direction of rotation of the cylinder |
| 28 | Glue transfer cylinder |
| 29 | Counterpressure cylinder |
| 30 | Gluing station according to the invention |
| 31 | Coating head or plate |
| 32 | Valves |
| 33 | Glue feed/hose |
| 44 | Glue trace interrupted at regular intervals |
| 45 | Short glue trace |
| 46 | Interrupted glue trace |
| 47 | Continuous glue trace |
| 48 | Unglued label |
| 71 | Glue release orifice |
| 76 | Lower side of the glue coating head 31 |
| 105 | Pressure regulator |
| 201 | Operating station |
| 202 | Computing unit |
| 203 | Display element |
| 204 | Operating terminal |
| 205 | Keyboard |
| 206 | Digital camera |
| 207 | Memory of the computing unit |
| 208 | Glue deposition |
| 209 | Interfaces |
| 200-216 | Connection |
| 217 | View of the label with glue spread |

1. Operating station (201) for a bottoming device for cross bottom sacks (19),
whereby the bottoming device comprises of a gluing station (30), in which the gluing format (4, 4a, 4b), according to which glue to be spread on the components of the sack (19), is defined by the glue traces (3), whose structure is determined through the opening and the closing of the valves (32) and
whereby the gluing station (30) is equipped with a computing unit (202), with which the selective opening and closing of the valves (32) can be done,
whereby digital target images of the glue traces (3), which define the gluing format (4, 4a, 4b) are stored in the memory (207) of the computing unit (202),
characterized in that a display element (203), by means of which the glue deposit (208) on the sack components (1, 2, 48) can be displayed.

2. Operating station (201) according to claim 1, characterized in that an operating terminal (204), through which changes can be made in the target images of the gluing traces (3,44-47)

3. Operating station (201) according to claim 2, characterized in that the operating terminal (204) comprises of
at least one manual input option—such as a keyboard (205)—and/or
interfaces (209), with which the digitalized data about the glue deposition can be transmitted.

4. Operating station (204) according to claim 2, characterized in that the operating station (204) is connected with a sack recognition system,
which includes sensory media—such as, for instance, a digital camera (6),
and recognizes the dimensions of the sack components (1, 2, 48), which (1, 2, 48) are to be transported to the gluing station (30).

5. Operating station (204) according to claim 1, characterized in that a computing unit (202), with which, from the digital target images, which represent the desired planar gluing format (4), the digital target images of the glue traces (3,44-47) can be calculated.

6. Operating station according to claim 1, characterized in that a computing unit (202), with which, based on the data related to the geometrical dimensions of the cross bottom sacks (19) and/or their later filling, the digital target images of the glue traces (3,44-47) can be calculated.

7. Operating station according to claim 1, characterized in that through the operating station (201)—preferably through the operating terminal (204)—the devices for adjusting the glue deposited per unit area of the sack components (1, 2) can be actuated.

8. Operating station according to claim 1, characterized in that
the operating station (201) is connected with the devices for the measurement of the glue deposit
and that the results of the measurements by the device for the measurement of the glue deposit are displayed on a display element (203), which is connected with the operating station (201).

9. Operating station according to claim 1, characterized in that the operating station (201)
is connected both with the devices for the measurement of the glue deposit
as well as with the devices for the adjustment of the glue deposit per unit area of the sack components (1, 2),
and that it is provided with a computing unit (202), which monitors and regulates the setting of the glue deposit.

10. Method for the operation of a bottomming device according to the preamble of the claim 1, characterized in that the digital target images,
which determine the structure of the glue traces (3,44-47), and which are stored, modified or supplemented in the memory (207) of the computing unit (202),
by transmitting the data to the operating station (201) through a keyboard (205) and/or digital interfaces (209).

11. Method according to claim 10, characterized in that the data, which is transmitted, is obtained in the following manner:
by means of a device, such as a scanner or a digital camera, which is suitable for the scanning of the gluing profile (4) of the sack component (1, 2),
through the editing of a glue profile with an external marking device, and/or through the editing of a glue profile in the operating station (201),

12. Method according to claim 10, characterized in that the target images of the glue traces (3, 44-47) or the gluing formats (4) are shown on a display element (203)—possibly also while they (3, 4, 44-47) are being modified.

13. Method according to claim 11, characterized through the following characteristic features
transmission of the target images of the gluing formats (4) to the memory of the computing unit (202)
calculations for conversion of the gluing formats (4) into glue traces (3,44-47)
possibly with the editing of the target images of the glue traces (3, 44-47) or of the gluing formats (4)
calculation of the opening and closing time points of the different valves (32) in dependence of the gluing speed (V).

14. Method according to claim 11 characterized through following characteristic features
transmission of the target images of the glue traces (3, 44-47) to the memory of the computing unit (202)
possibly with the editing of the target images of the glue traces (3, 44-47) or of the gluing formats (4)
calculation of the opening and closing time points of the different valves (32) in dependence of the gluing speed (V).
